(19) United States
(12) Patent Application Publication
(10) Pub. No.: US 2024/0376726 A1
(43) Pub. Date: Nov. 14, 2024

(54) Attic Standing Platform Device

(71) Applicant: Rick Goldstein, Palm Beach, FL (US)

(72) Inventor: Rick Goldstein, Palm Beach, FL (US)

(21) Appl. No.: 18/440,385

(22) Filed: Feb. 13, 2024

Related U.S. Application Data
(60) Provisional application No. 63/465,053, filed on May 9, 2023.

(51) Int. Cl. E04G 3/22

(52) U.S. Cl. CPC E04G 3/22

(57) ABSTRACT

An attic standing platform device is provided. The device is primarily comprised of a body attached to at least one mounting bracket via at least one hinge. The device can be positioned between an opening in the parallel frame members and/or perpendicular frame members of an attic frame. A user can then deploy and stand on the body while moving items or completing tasks in an attic. Therefore, a user need not stand on an unstable attic ladder to complete said tasks.

### CROSS-REFERENCE TO RELATED APPLICATION

The present application claims priority to, and the benefit of, U.S. Provisional Application No. 63/465,053, which was filed on May 9, 2023, and is incorporated herein by reference in its entirety.

### FIELD OF THE INVENTION

The present invention relates generally to the field of attic platforms. More specifically, the present invention relates to an attic standing platform device that provides a user with a stable standing platform within an attic. Accordingly, the present disclosure makes specific reference thereto. Nonetheless, it is to be appreciated that aspects of the present invention are also equally applicable to other like applications, devices, and methods of manufacture.

### BACKGROUND

Many homes have attic spaces. Some individuals may use said attic spaces to store various items. However, trying to move or remove items within an attic while standing on an attic ladder can greatly increase the risk of injury from the ladder due to falling.

Therefore, there exists a long-felt need in the art for a device that reduces the risk of falling from an attic ladder. There also exists a long-felt need in the art for an attic standing platform device that provides a user with a stable area to stand on while removing or moving items from within an attic. Further, there exists a long-felt need in the art for an attic standing platform device that provides a user with a stable area to stand on while removing or moving items from within an attic and wherein the device does not obstruct a user's ability to enter or exit the attic via an attic ladder.

The subject matter disclosed and claimed herein, in one embodiment thereof, comprises an attic standing platform device. The device is primarily comprised of a body attached to at least one mounting bracket via at least one hinge. The device is designed to be positioned between an opening in the parallel frame members and/or perpendicular frame members of an attic frame in a home or building, wherein a user can deploy and stand on the body while moving items or completing tasks in an attic. Therefore, a user need not stand on an unstable attic ladder to complete said tasks. When not in use, the body can be rotated away from the ladder via the hinge to allow a user to climb up/down the ladder.

In this manner, the attic standing platform device of the present invention accomplishes all the forgoing objectives and provides a device that reduces the risk of falling from an attic ladder by providing a user with a stable area to stand on while removing or moving items from within an attic. Further, the hinged construction of the device allows the device to be rotated to ensure the device does not obstruct a user's ability to enter or exit the attic via an attic ladder.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an attic standing platform device. The device is primarily comprised of a body attached to at least one mounting bracket via at least one hinge. The device is designed to be positioned between an opening in the parallel frame members and/or perpendicular frame members of an attic frame in a home or building. The mounting bracket may be removably attached to the frame members preferably via at least one fastener secured through at least one opening of the bracket.

The body of the device may be generally square or rectangular in shape with at least two side walls and one bottom wall. However, in the preferred embodiment the body is generally U-shaped. A user can stand in the interior space (on top of the bottom wall) of the body such that they have a more stable platform than an attic ladder to grab or move items in an attic.

The body attaches to the mounting bracket via at least one hinge. The body can rotate around the hinge within degrees (relative to the mounting bracket. As a result, the body can be moved as needed while a user is climbing an attic ladder such that the body does not obstruct the ladder until a user deploys the device.

When a user desires to stand on the body to perform tasks within the attic, the body can be pulled down towards the ladder such that at least one perpendicular top wall of the body is parallel with and rests on at least one arm of the mounting bracket. Then, at least one receiving area of the body engages at least one fastener on the mounting bracket. In one embodiment, the receiving area is an opening and the fastener is comprised of a rotating, locking fastener. In this manner, the fastener is positioned through the area and can then be turned 90 degrees to secure (i.e., lock) the body to the mounting bracket such that the body cannot move while a user stands in the interior space of the body.

To allow the body to be easily moved about the hinge during use, the body may be comprised of at least one handle that a user can grab. The handle may be in the form of an opening in the bottom wall of the body or may be comprised of a handle that extends from the bottom wall. The body may also be comprised of at least one rod preferably attached to the bottom wall of the body via at least one hinge point that allows the rod to swivel/move during use in a position towards the user to make the body easier to manipulate when the body is in the farthest position from the attic ladder.

The present invention is also comprised of a method of using the device. First, a device is provided comprised of a body attached to at least one mounting bracket via at least one hinge. Then, the mounting bracket can be secured to at least one parallel frame member of an attic, and potentially at least one perpendicular frame member of an attic, via at least one mounting fastener. Once secured, a user can rotate the body towards an attic ladder such that a user can stand in the interior space of the body to remove items from the attic or complete other various attic-related tasks. Once finished with said tasks, a user can return to the ladder from the body and can then rotate the body away from the ladder about the hinge such that the user can climb down the ladder.

Accordingly, the attic standing platform device of the present invention is particularly advantageous as it reduces the risk of falling from an attic ladder by providing a user with a stable area to stand on while removing or moving items from within an attic. Further, the hinged construction of the device allows the device to be rotated to ensure the device does not obstruct a user's ability to enter or exit the attic via an attic ladder. In this manner, the attic standing platform device provides a safer solution for individuals accessing items within an attic.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an attic standing platform device of the present invention while locked in accordance with the disclosed architecture;

FIG. 2 illustrates a perspective view of one potential embodiment of an attic standing platform device of the present invention while unlocked in accordance with the disclosed architecture;

FIG. 3 illustrates a perspective view of one potential embodiment of an attic standing platform device of the present invention while locked and attached to an attic frame in accordance with the disclosed architecture;

FIG. 4 illustrates a perspective view of one potential embodiment of an attic standing platform device of the present invention while unlocked and attached to an attic frame in accordance with the disclosed architecture;

FIG. 5 illustrates a perspective view of one potential embodiment of an attic standing platform device of the present invention while locked and attached to an attic frame while a user is standing within the device in accordance with the disclosed architecture; and

FIG. 6 illustrates a flowchart of a method of using one potential embodiment of an attic standing platform device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that reduces the risk of falling from an attic ladder. There also exists a long-felt need in the art for an attic standing platform device that provides a user with a stable area to stand on while removing or moving items from within an attic. Further, there exists a long-felt need in the art for an attic standing platform device that provides a user with a stable area to stand on while removing or moving items from within an attic and wherein the device does not obstruct a user's ability to enter or exit the attic via an attic ladder.

The present invention, in one exemplary embodiment, is comprised of an attic standing platform device primarily comprised of a body attached to at least one mounting bracket via at least one hinge. The device can be positioned between an opening in the parallel frame members and/or perpendicular frame members of an attic frame in a home or building. The mounting bracket may be removably attached to the frame members preferably via at least one fastener secured through at least one opening of the bracket.

The body of the device may be generally square or rectangular in shape with at least two side walls and one bottom wall. In the preferred embodiment the body is generally U-shaped. A user can stand in the interior space (on top of the bottom wall) of the body such that they have a more stable platform than an attic ladder to grab or move items in an attic.

The body attaches to the mounting bracket via at least one hinge, wherein the body can rotate around the hinge within degrees (relative to the mounting bracket. As a result, the body can be moved as needed while a user is climbing an attic ladder such that the body does not obstruct the ladder until a user deploys the device.

When a user desires to stand on the body to perform tasks within the attic, the body can be pulled down towards the ladder such that at least one perpendicular top wall of the body is parallel with and rests on at least one arm of the mounting bracket. Then, at least one receiving area of the body engages at least one fastener on the mounting bracket. The receiving area is preferably an opening and the fastener is preferably comprised of a rotating, locking fastener. In this manner, the fastener is positioned through the area and can then be turned 90 degrees to secure (i.e., lock) the body to the mounting bracket such that the body cannot move while a user stands in the interior space of the body.

To allow the body to be easily moved about the hinge during use, the body may be comprised of at least one handle that a user can grab. The handle may be in the form of an opening in the bottom wall of the body or may be comprised of a handle that extends from the bottom wall. The body may also be comprised of at least one rod preferably attached to the bottom wall of the body via at least one hinge point that allows the rod to swivel/move during use in a position towards the user to make the body easier to manipulate when the body is in the farthest position from the attic ladder.

The present invention is also comprised of a method of using the device. First, a device is provided comprised of a body attached to at least one mounting bracket via at least one hinge. Then, the mounting bracket can be secured to at least one parallel frame member of an attic, and potentially at least one perpendicular frame member of an attic, via at least one mounting fastener. Once secured, a user can rotate the body towards an attic ladder such that a user can stand in the interior space of the body to remove items from the attic or complete other various attic-related tasks. Once finished with said tasks, a user can return to the ladder from the body and can then rotate the body away from the ladder about the hinge such that the user can climb down the ladder.

Accordingly, the attic standing platform device of the present invention is particularly advantageous as it reduces the risk of falling from an attic ladder by providing a user with a stable area to stand on while removing or moving items from within an attic. Further, the hinged construction of the device allows the device to be rotated to ensure the device does not obstruct a user's ability to enter or exit the attic via an attic ladder. In this manner, the attic standing platform device provides a safer solution for individuals accessing items within an attic.

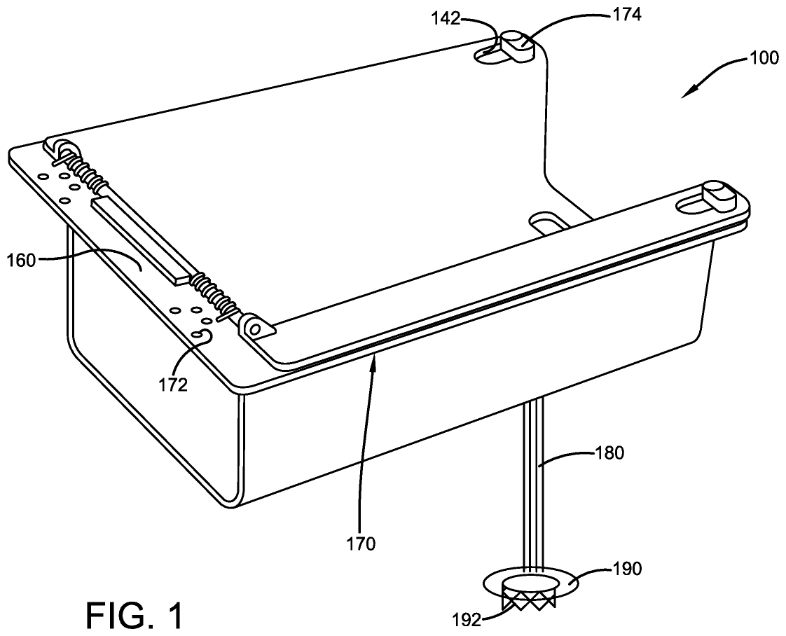

Referring initially to the drawings, FIG. 1 illustrates a perspective view of one potential embodiment of an attic standing platform device 100 of the present invention while locked in accordance with the disclosed architecture. The device 100 is primarily comprised of a body 110 attached to at least one mounting bracket 160 via at least one hinge 162. The device 100 is designed to be positioned between an opening in the parallel frame members 10 and/or perpendicular frame members 20 of an attic frame in a home or building.

More specifically, the mounting bracket 160 may be removably attached to the frame members 10,20 preferably via at least one fastener 194 secured through at least one opening 172 of the bracket 160 (wherein the opening 172 may be on the arm 170 or any other area of the bracket 160). The fastener 194 is preferably a screw but may be other fasteners such as but not limited to bolt, nail, adhesive, etc., or any other fastener 194 of a like that can secure the mounting bracket 160 to the frame members 10,20.

The body 110 of the device 100 is preferably made from a rigid plastic or lightweight metal material that can support at least 80 pounds (to support the weight of an adult standing on the body 110 during use). In body 110 may be generally square or rectangular in shape with at least two side walls 120 and one bottom wall 130. However, in the preferred embodiment the body 110 is generally U-shaped. A user can stand in the interior space 150 (on top of the bottom wall 130) of the body 110 such that they have a more stable platform than an attic ladder 30 to grab or move items in an attic.

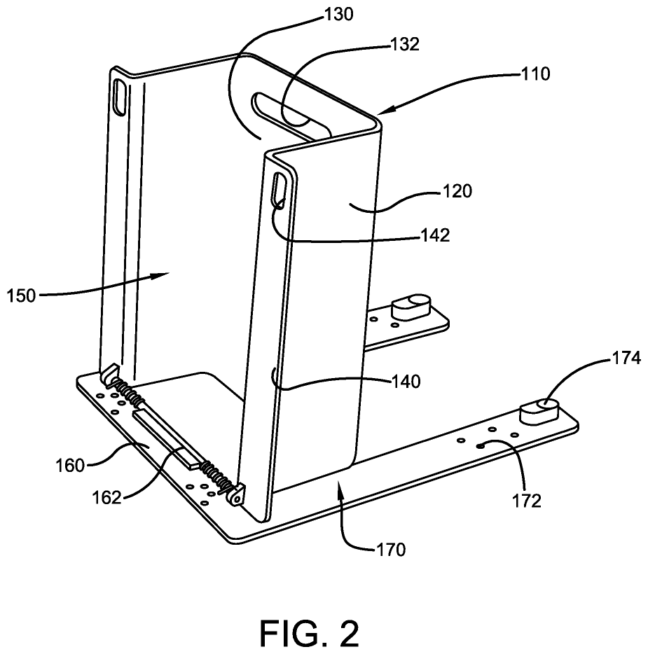

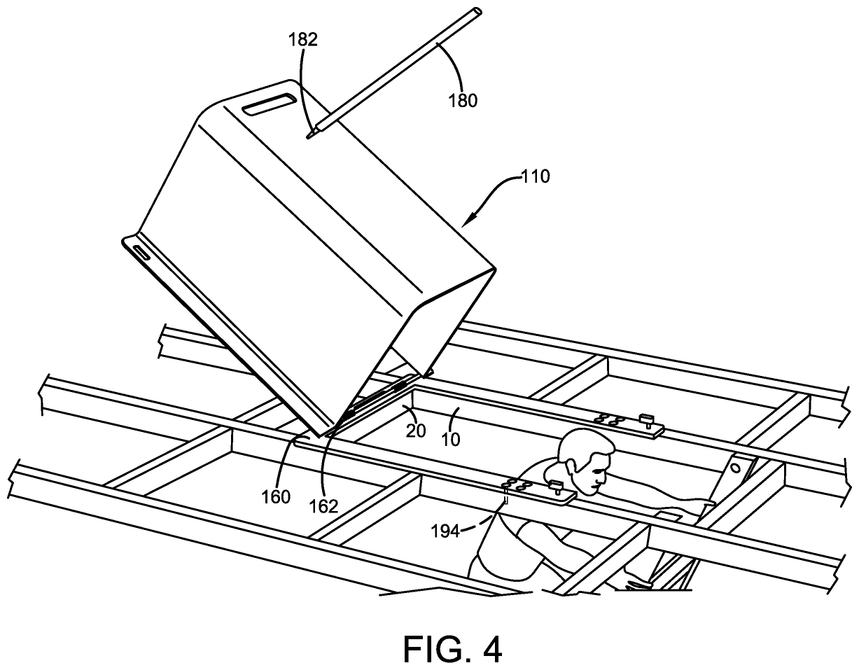

The body 110 attaches to the mounting bracket 160 via at least one hinge 162. The hinge 162 is preferably but not limited to a spring-loaded hinge. The body 110 can rotate around the hinge 162 within 180 degrees (relative to the mounting bracket 160), as seen in FIG. 2 and FIG. 4. In this manner, the body 110 can be moved as needed while a user is climbing an attic ladder 30 such that the body 110 does not obstruct the ladder 30 until a user deploys the device 100.

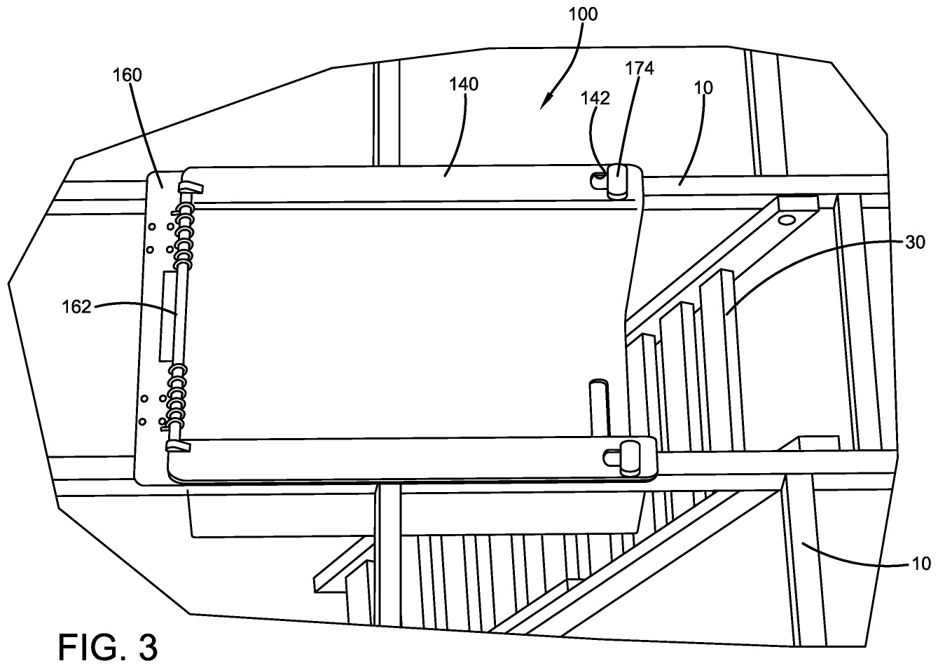

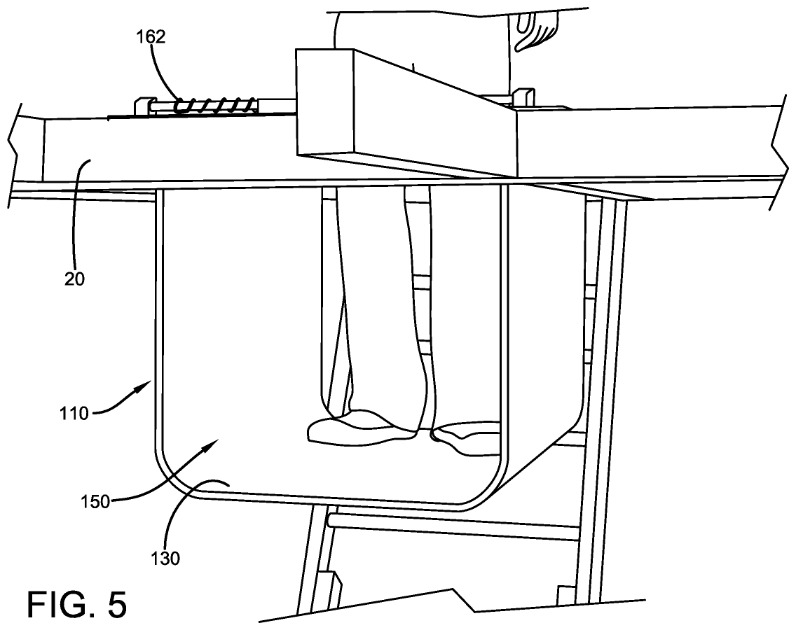

When a user desires to stand on the body 110 to perform tasks within the attic, the body 110 can be pulled down towards the ladder 30 such that at least one perpendicular top wall 140 of the body 110 is parallel with and rests on at least one arm 170 of the mounting bracket 160, as seen in FIG. 3 and FIG. 5. The top wall 140 is comprised of at least one receiving area 142. The receiving area 142 engages at least one fastener 174 on the mounting bracket 160, and more specifically on the arm 170 of the bracket 160.

In one embodiment, the receiving area 142 is an opening and the fastener 174 is comprised of a rotating, locking fastener. In this manner, the fastener 174 is positioned through the area 142 and can then be turned 90 degrees to secure (i.e., lock) the body 110 to the mounting bracket 160 such that the body 110 cannot move while a user stands in the interior space 150 of the body 110, as seen in FIG. 5. However, the fastener 174 and receiving area 142 may be any type of reciprocating fasteners or securing methods known in the art such as but not limited to eyelet and latch, magnets, bolt and nut, a fastener and an opening, etc.

To allow the body 110 to be easily moved about the hinge 162 during use, the body 110 may be comprised of at least one handle 132 that a user can grab. The handle 132 may be in the form of an opening in the bottom wall 130 of the body 110 or may be comprised of a handle that extends from the bottom wall 130, wherein the handle 132 is of any type known in the art.

In order to allow the body 110 to be easily manipulated wherein the body 110 is rotated about the hinge 162 in the farthest position from the attic ladder 30, the body 110 may be comprised of at least one rod 180. The rod 180 is preferably attached to the bottom wall 130 of the body 110 via at least one hinge point 182 (as seen in FIG. 4) that allows the rod 180 to swivel/move during use in a position towards the user to make the body 110 easier to manipulate when the body 110 is in the farthest position from the attic ladder 30.

The rod 180 may be comprised of at least one handle 190 to make the rod 180 casier to grab. The handle 190 may be of any type or style known in the art. The handle 190 may be comprised of a grip area 192 made from a non-slip material such as but not limited to rubber. The grip area 192 may be comprised of a recessed or raised texture to further improve grip.

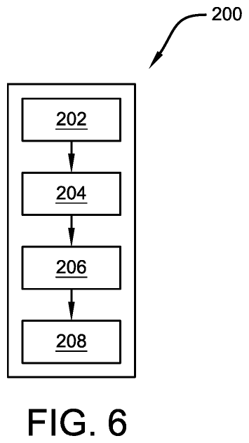

The present invention is also comprised of a method of using 200 the device 100, as seen in FIG. 6. First, a device 100 is provided comprised of a body 110 attached to at least one mounting bracket 160 via at least one hinge 162 [Step 202]. Then, the mounting bracket 160 can be secured to at least one parallel frame member 10 of an attic, and potentially at least one perpendicular frame member 20 of an attic, via at least one mounting fastener 194 [Step 204]. Once secured, a user can rotate the body 110 towards an attic ladder 30 such that a user can stand in the interior space 150 of the body 110 to remove items from the attic or complete other various attic-related tasks [Step 206]. Once finished with said tasks, a user can return to the ladder 30 from the body 110 and can then rotate the body 110 away from the ladder 30 about the hinge 162 such that the user can climb down the ladder [Step 208]. It should be noted that manipulation of the body 110 may be aided by grasping a rod 180 attached to the body 110.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “attic standing platform device” and “device” are interchangeable and refer to the attic standing platform device 100 of the present invention.

Notwithstanding the forgoing, the attic standing platform device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the attic standing platform device 100 as shown in the FIGS. are for illustrative purposes only, and that many other sizes and shapes of the attic standing platform device 100 are well within the scope of the present disclosure. Although the dimensions of the attic standing platform device 100 are important design parameters for user convenience, the attic standing platform device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attic standing platform device comprising:
a mounting bracket comprised of a fastener;
a body attached to the mounting bracket via a first hinge, the body comprised of a receiving area for the fastener; and
a rod attached to the body via a hinge point.

2. The attic standing platform device of claim 1, wherein the mounting bracket is comprised of an opening.

3. The attic standing platform device of claim 1, wherein the fastener is comprised of a rotating, locking fastener.

4. The attic standing platform device of claim 1, wherein the receiving area is comprised of an opening.

5. The attic standing platform device of claim 1, wherein the body is comprised of a handle opening.

6. The attic standing platform device of claim 1, wherein the hinge point is comprised of a second hinge.

7. The attic standing platform device of claim 1, wherein the body is comprised of a U-shaped body.

8. The attic standing platform device of claim 1, wherein the body is comprised of a side wall.

9. The attic standing platform device of claim 1, wherein the body is comprised of a bottom wall.

10. An attic standing platform device comprising:
a mounting bracket comprised of a fastener;
a body attached to the mounting bracket via a hinge, the body comprised of a reciprocating fastener; and
a rod attached to the body via a hinge point, the rod comprised of a handle.

11. The attic standing platform device of claim 10, wherein the mounting bracket is comprised of an opening.

12. The attic standing platform device of claim 10, wherein the body is comprised of a square body.

13. The attic standing platform device of claim 10, wherein the body is comprised of a rectangular body.

14. The attic standing platform device of claim 1, wherein the handle is comprised of a grip area.

15. The attic standing platform device of claim 10, wherein the grip area is comprised of a texture.

16. The attic standing platform device of claim 10, wherein the body can rotate 180 degrees around the hinge.

17. The attic standing platform device of claim 10, wherein the hinge point is positioned on a bottom surface of a bottom wall of the body.

18. A method of using an attic standing platform device, the method comprising the following steps:
providing an attic standing platform device comprised of a body attached to a mounting bracket via a hinge;
securing the mounting bracket to an attic frame member via a fastener;
rotating the body towards an attic ladder;
standing in an interior space of the body; and
rotating the body away from the attic ladder about the hinge.

19. The method of claim 18, wherein the body is comprised of a four-sided body.

20. The method of claim 18, wherein the body is comprised of a three-sided body.
